(19) United States
(12) Patent Application Publication
(10) Pub. No.: US 2006/0135691 A1
(43) Pub. Date: Jun. 22, 2006

(54) Foaming additives

(75) Inventor: Jeffrey Jacob Cernohous, Hudson, WI (US)

Correspondence Address: FOLEY AND LARDNER LLP;SUITE 500, 3000 K STREET NW, WASHINGTON, DC, 20007, US

(73) Assignee: PHILLIPS PLASTICS CORPORATION

(21) Appl. No.: 11/284,414

(22) Filed: Nov. 21, 2005

Related U.S. Application Data
(60) Provisional application No. 60/630,355, filed on Nov. 22, 2004.
(60) Provisional application No. 60/641,526, filed on Jan. 5, 2005.
(60) Provisional application No. 60/675,706, filed on Apr. 28, 2005.

(51) Int. Cl. C08L 51/04; C08L 53/00; C08G 63/48; C08G 63/91; B32B 3/26

(52) U.S. Cl. 525/71; 428/304.4

(57) ABSTRACT

An additive may be used to foam and/or otherwise alter the physical properties of a polymeric material. In particular, a foaming additive may be used to foam a polymeric composite material. The foaming additive may include a blowing agent and a surfactant. The surfactant may be an amphiphilic block copolymer.

### CROSS-REFERENCE TO RELATED PATENT APPLICATIONS

This patent application claims priority under 35 U.S.C. § 119(e) to the following patent applications: (1) U.S. Provisional Patent Application No. 60/630,355, entitled “Compositions and Methods for Foaming Highly Filled Polymers,” filed on Nov. 22, 2004, (2) U.S. Provisional Patent Application No. 60/641,526, entitled “Compatibilized Foaming Additives,” filed on Jan. 5, 2005, and (3) U.S. Provisional Patent Application No. 60/675,706, entitled “Dispersible Foaming Additives,” filed on Apr. 28, 2005, all of which are hereby expressly incorporated herein by reference in their entireties.

### BACKGROUND

Polymeric materials have been used for a number of years to make a wide variety of end products. In many applications, additives and/or fillers may be added to the polymeric materials to modify or improve one or more properties of the polymeric materials. For example, in many situations, it is desirable to reduce the density and/or enhance other properties of the polymeric material. This may be accomplished by adding a blowing agent to the polymeric material during processing. The blowing agent is used to create voids or cells in the polymeric material. Polymeric materials that contain voids are commonly referred to as foams. Depending on the degree of foaming, that is, the volume fraction of the foam making up the voids, the properties of such materials may be remarkably different from the basic material.

Common blowing agents include chemicals that can be incorporated into the polymeric material that lead to the development of cells through the release of a gas at the appropriate time during processing. The amount and types of blowing agents influences the density of the finished product by its cell structure. The release of gas in the polymeric material results in a uniform or, in some cases, nonuniform cellular structure. The cells of some foamed polymeric materials are large enough to be seen, while cells in others are so fine that a microscope is needed to see the cells.

Fillers may also be used to enhance the properties and lower the costs associated with making end products from polymeric materials. Polymeric materials that include fillers are commonly referred to as composite materials. In many situations, the filler may be a material such as an inorganic material or cellulosic material that is incompatible with the polymeric component or matrix of the composite material. This makes it difficult to disperse the filler in the polymeric component of the composite material. One area of recent interest is in the creation of wood polymer composites (WPCs) for use in a wide variety of applications such as structural building components, automobile components, and so forth. In particular, there has been a significant amount of interest in developing foamed composite materials. In the field of wood polymer composites, the goal is to provide a composite material that looks and feels similar to wood (e.g., same color, density, etc.) but that is more durable and requires less maintenance.

Unfortunately there are a number of obstacles that stand in the way of developing robust, cost-effective strategies for producing highly filled, foamed materials. One significant obstacle is that foaming highly filled materials often causes melt defects during processing of the melt processable composite material. Typical melt processing of foamable composite materials involves passing the melt processable composite material through a die or orifice in an extrusion process. If the composite material is processed too slowly, the end product may be economically unfeasible to make. However, if the melt processable composite material is processed above a critical shear rate, the surface of the extrudate is much more likely to exhibit melt defects such as melt fracture, surface roughness, edge tear, sharkskin, and so forth. Melt fracture or edge tear (i.e., a rough surface on the extrudate of the material) is one of the more common melt defects that occur during melt processing. This phenomenon is particularly problematic for composite materials. The addition of fillers to the polymeric material increases the overall melt viscosity, which makes it more difficult to process the composite material and results in even more melt defects. When blowing agents are added, additional melt defects can occur that include non-uniform foaming and rough and uneven surface texture. Thus, it has proven difficult to create commercially viable highly filled, foamed composite materials.

Accordingly, it would be desirable to provide improved end products made from polymeric materials, particularly improved foamed composite materials, that have fewer melt defects and that can be made economically from both a product through-put standpoint and a raw materials cost stand-point.

### SUMMARY

A wide variety of additives and/or melt processable compositions are described herein that may be used to make an equally wide variety of end products such as structural building components, automobile components, and so forth. The additives and/or melt processable compositions may be used to make structural building components such as fencing products (e.g., posts, rails, and so forth), shingles, decking products (e.g., support beams, decking members, and so forth), siding, and so forth. The end products such as the building components may be solid polymeric materials, foamed materials, solid composite materials, and/or foamed composite materials. In order to reduce costs and provide a product that has similar properties to natural wood, a structural building component may be made from foamed composite materials, and, specifically, the structural building components may be foamed WPCs. Foaming the composite material may allow the structural component to accept screws and nails more like real wood than its unfoamed counterparts. Also, internal pressures created by foaming may give better surface definition and sharper contours and corners than unfoamed profiles. Although there are numerous applications for foamed composite materials, many applications are for end products that are exposed to the elements such as exterior building members. It should be appreciated that virtually any end product may be made using the additives and/or foamable materials described herein.

A number of additives are described herein that may be used to foam and/or otherwise improve the properties or usefulness of a polymeric material. For example, a foaming additive may be used to foam a polymeric material to reduce the raw material costs of the finished foamed material or product or control the density of the finished foamed material or for any of a number of additional reasons. The foaming additive may provide a uniform or nonuniform cellular structure in the foamed material depending on the application. In most situations, however, it is desired to provide a uniform or substantially uniform cellular structure in the foamed material. The foaming additive may comprise a blowing agent, a polymeric carrier material, a compatibilizer, and/or a dispersion aid. The foaming additive may include any suitable combination of these materials in any suitable amount. In addition, the foaming additive may also include additional materials such as a filler that may act as a nucleating agent (e.g., talc). The foaming additive is typically sold as a separate material to end users that use the additive to foam various materials such as composite materials.

In another example, a melt resistant additive may be used to improve mar and wear properties of an end product. The melt resistant additive may be used with a foamed or unfoamed material or with a solid polymeric material or a composite material. The melt resistant additive may include a polyolefin having a molecular weight of at least about 500,000. The melt resistant additive may also include fluorocarbons such as polytetrafluoroethylene. The melt resistant additive may be provided separately or as part of a foaming additive or with any other combination of additives.

It should be appreciated that the additives described herein may be provided in any of a number of suitable forms. For example, the dispersion aid may be provided as a physically separate material that is added to the polymeric material at the same time as the other additives. Likewise, the compatibilizer, blowing agent, melt resistant additive, and so forth may all be provided as physically separate materials that can be added to the polymeric material. In other embodiments, the additives may be provided as stand alone master batchs or concentrates that include all of the various components in the appropriate amounts. This may make it easier for the end user to add the additive to the polymeric materials since the end user does not have to separately measure each individual component. This also makes it easier to transport and store the additives since there is only one product that must be handled as opposed to numerous separate additives. The additives may be provided to the end user as a solid or as a melt.

The additives described herein may be combined with any suitable polymeric material alone or with one or more fillers to form a melt processable composition that can be melt processed to form any of a number of end products. The polymeric component of the melt processable composition may include one or more of any suitable polymer such as any suitable hydrocarbon polymer. In one embodiment, the polymeric component may include a polyolefin such as polyethylene or polypropylene. In another embodiment, the polymeric component may include polyvinyl chloride, polyethylene, polystyrene, and/or polypropylene. The polymeric component may include a thermoplastic polymeric material (i.e., softens upon heating and becomes firm or hardens upon cooling) or a thermosetting polymeric material (i.e., permanently hardens or becomes firm upon heating). Also, the polymeric component may be a thermoplastic polymeric component or a thermosetting polymeric component.

As mentioned previously, a filler may be combined with a polymeric material to form a composite material. Fillers may be added to reduce costs and/or to impart desired physical characteristics to the composite material. The fillers may include various organic and/or inorganic materials. Typically, the fillers are mixed throughout the polymeric component to form a uniform or nearly uniform mixture. In one embodiment, the composite material may include a hydrophilic filler. In another embodiment, the composite material may include a cellulosic filler. In yet another embodiment, the composite material may include wood flour and/or wood fiber.

The melt processable composition may be processed using melt processing techniques to form the desired end product. Melt processes that may be used include extrusion, injection molding, blow molding, rotomolding, batch mixing, and the like. In many situations, the melt processable composition is extruded to form the desired end product. In one embodiment, the polymeric material is combined with a foaming additive and optionally any other additives and/or fillers to form the melt processable composition. The melt processable composition is then heated to a temperature sufficient to foam the material.

### DETAILED DESCRIPTION

Although the subject matter described herein is described primarily in the context of foaming composite materials, it should be appreciated that the foaming additives and/or any other additives may also be used to foam or otherwise change the properties of one or more polymeric materials without the addition of any other fillers. For example, the additives described herein may be used to prepare solid polymeric materials, foamed polymeric materials, solid composite materials, and/or foamed composite materials. It should be appreciated that the polymeric materials may include any of the additives, fillers, etc., in any suitable amount to produce a foamed or unfoamed article.

Numerous additives may be used with polymeric materials to modify and/or improve the properties of the polymeric material. Additives that may be used with polymeric materials include foaming additives, melt resistant additives, and/or numerous additional miscellaneous additives. In one embodiment, a foaming additive or foaming agent may include a blowing agent, a polymeric carrier, a compatibilizer, and/or a dispersion aid. The foaming additive may include these materials in any suitable amounts and/or combinations.

A blowing agent or gas producing additive may be included in the foaming additive. Blowing agents are materials that can be incorporated into the melt processable composition (e.g., the premix of the additives, polymeric matrix, and/or optional fillers, either in melt in solid form) and that lead to the development of cells through the release of a gas at the appropriate time during processing. The amount and types of blowing agents influences the density of the finished product by its cell structure. Any suitable blowing agent may be used to produce the foamed material. However, preferably, the blowing agent includes a hydrophilic blowing agent.

There are two major types of blowing agents: physical and chemical. Physical blowing agents tend to be volatile liquids or compressed gases that change state during melt processing to form a cellular structure. Chemical blowing agents tend to be solids that decompose thermally to form gaseous decomposition products. The gases produced are finely distributed in the melt processable composition to provide a cellular structure.

In addition, blowing agents can be divided into two major classifications; organic and inorganic. Organic blowing agents are available in a wide range of different chemistries, physical forms and modification, such as, for example, azodicarbonamide. Inorganic blowing agents tend to be more limited. An inorganic blowing agent may include one or more carbonate salts such as Sodium, Calcium, Potassium, and/or Magnesium carbonate salts. Preferably, sodium bicarbonate is used because it is inexpensive and readily decomposes to form carbon dioxide gas. Sodium bicarbonate gradually decomposes when heated above about 120° C. with significant decomposition occurring between 150° C. and 200° C. In general, the higher the temperature, the more quickly the sodium bicarbonate decomposes. An acid such as citric acid may also be included in the foaming additive (or added directly to the melt processable composition) to facilitate decomposition of the blowing agent. Chemical blowing agents are usually supplied in powder form or pellet form. The specific choice of the blowing agent will be related to the cost, desired cell development and gas yield and the desired properties of the foamed material.

Suitable examples of blowing agents include water, carbonate salts and other carbon dioxide releasing materials, diazo compounds and other nitrogen producing materials, carbon dioxide, decomposing polymeric materials such as poly (t-butylmethacrylate) and polyacrylic acid, alkane and cycloalkane gases such as pentane and butane, inert gases such as nitrogen, and the like. The blowing agent may be hydrophilic or hydrophobic. In one embodiment, the blowing agent may be a solid blowing agent. In another embodiment, the blowing agent may include one or more carbonate salts such as sodium, potassium, calcium, and/or magnesium carbonate salts. In yet another embodiment, the blowing agent may be inorganic. The blowing agent may also include sodium carbonate and/or sodium bicarbonate, or, alternatively, sodium bicarbonate alone.

Although the foaming additive may include only the blowing agent, a more typical situation is where the foaming additive includes a polymeric carrier that is used to carry or hold the blowing agent. The blowing agent may be dispersed in the polymeric carrier for transport and/or handling purposes. The polymeric carrier may also be used to hold or carry any of the other materials or additives in the foaming additive.

The inclusion levels of the blowing agent in the foaming additive may vary widely. In some embodiments, the foaming additive includes at least about 2.5 wt % of blowing agent, at least about 5 wt % of blowing agent, or, suitably, at least about 10 wt % of blowing agent. In other embodiments, the foaming additive may include about 10 to 60 wt % of blowing agent, about 15 to 50 wt % of blowing agent, or, suitably, about 20 to 45 wt % of blowing agent. In yet further embodiments, the foaming additive may include about 0.05 to 90 wt % of blowing agent, about 0.1 to 50 wt % of blowing agent, or about 1 to 26 wt % of blowing agent.

As mentioned previously, the foaming additive may also include a polymeric carrier or material that is used to hold the other additives to form a single additive. The polymeric carrier or polymeric component may be any suitable polymeric material such as hydrocarbon or non-hydrocarbon polymers. The polymeric carrier should be capable of being melted or melt processed at temperatures below the activation temperature of the blowing agent. In some instances, however, a polymeric component having a melting point above the activation temperature of the blowing agent may be used as long as it is processed quickly enough so that a suitable amount of active blowing agent remains. In one embodiment, the polymeric carrier has a melting point of no more than about 150° C., no more than about 125° C., no more than about 100° C., or, suitably, no more than about 80° C.

Although any suitable polymeric carrier may be used, thermoplastic polymeric carriers are typically used because thermoplastic materials allow for repeated softening and hardening of the polymeric carrier, which may occur, for example, when the foaming additive is first formed and when the foaming additive is mixed in the melt processable composition. In one embodiment, suitable thermoplastic polymeric carriers include thermoplastic elastomers such as styrene-butadiene-styrene (SBS), styrene-isoprene-styrene (SIS), styrene-ethylene-butylene-stryrene (SEBS) and polyolefin copolymers such as poly(ethylene-co-octene), poly(ethylene-co-hexene), poly(ethylene-co-vinyl alcohol), poly(ethylene-co-vinyl acetate) that can be melted at temperatures below the decomposition temperature of the blowing agent (or slightly above the decomposition temperature as long as there is minimal decomposition). The MW of these thermoplastic polymeric carriers may be adjusted to provide the desired characteristics.

Since there are a number of suitable polymeric materials that may be used as the polymeric carrier in the foaming additive, the choice of which polymeric material to use often comes down to which is readily available and the lowest cost yet still has the necessary melting characteristics to allow the polymeric material to be melt processed with the selected blowing agent. The foaming additive may include at least about 10 wt % of polymeric carrier, at least about 15 wt % of polymeric carrier, or, suitably, at least about 20 wt % of polymeric carrier. The foaming additive may also include no more than about 70 wt % of polymeric carrier, no more than about 80 wt % of polymeric carrier, or, suitably, no more than about 90 wt % of polymeric carrier. The foaming additive may also include about 20 to 60 wt % of polymeric carrier or, suitably, about 30 to 55 wt % of polymeric carrier.

A compatibilizer, surfactant, or coupling agent is a material that improves the dispersion and uniformity of one material in another otherwise incompatible material. The compatibilizer does this by reducing the surface energy between the two materials. For example, the compatibilizer may be included in the foaming additive to make otherwise incompatible materials in the melt processable composition compatible. For example, the compatibilizer may make an inorganic hydrophilic blowing agent such as sodium bicarbonate more compatible with a hydrophobic polymeric carrier in the foaming additive or a hydrophobic polymeric component of the melt processable composition. Without the compatibilizer, a hydrophilic blowing agent tends to associate with other hydrophilic materials in the melt processable composition such as hydrophilic fillers, other particles of blowing agents, etc. If the melt processable composition is foamed in this state, the gas produced by the blowing agents tends to form non-uniform cells and/or follows the hydrophilic fillers to the surface and escapes. For this reason, it is desirable to uniformly disperse the hydrophilic blowing agent throughout the polymeric component of the melt processable composition so that when the blowing agent produces gas, the gas is encapsulated in and expands in a film or matrix of the polymeric component. The voids produced in this situation tend to be more uniform and well developed. The compatibilizer may also be used to make hydrophilic cellulosic fillers such as wood as well as other hydrophilic fillers compatible with the polymeric component of the melt processable composition. Improving dispersion of these otherwise incompatible components allows for the more uniform foaming and/or mixing of the components.

It should be appreciated that any suitable compatibilizer may be used in the foaming additive. In general, the compatibilizer is chosen so that it is amphiphilic. Amphiphilic materials generally contain a segment that is compatible with one type of material and another segment that is compatible with another type of material. For example, the compatibilizer may have a hydrophobic segment and a hydrophilic segment. The compatibilizer may also be either monomeric or polymeric. In one embodiment, the compatibilizer is chosen so that it compatibilizes the blowing agent and the polymeric component of the melt processable composition. Suitable compatibilizers include anionic surfactants, nonionic surfactants, end functionalized polymers, and/or amphiphilic block copolymers.

In one embodiment, the compatibilizer includes an amphiphilic polymer. The polymer may be ionic or nonionic. The polymer may also include one, two, three, four, or more base monomer units. The polymer may also be a graft or radial block copolymer. Preferably, the amphiphilic polymer is a nonionic block copolymer. The amphiphilic properties of the copolymer may be manifest more when the block copolymer is a diblock copolymer where one block is hydrophobic and the other block is hydrophilic. Thus, the blocks of an amphiphilic diblock copolymer are immiscible with each other. It should be appreciated, however, that any amphiphilic polymer may be used as the compatibilizer. In one embodiment, the amphiphilic polymer may include a polyolefin segment and a polyalkylene oxide segment. For example, the amphiphilic polymer may be polyethylene-b-ethylene oxide block copolymers. In another embodiment, the amphiphilic polymer may be an end functionalized polyolefin (e.g., polyethylene or polypropylene) where the functionalized end is hydrophilic.

The foaming additive may include any suitable amount of compatibilizer as needed under the circumstances. In one embodiment, the foaming additive includes no more than about 10 wt % compatibilizer or no more than about 5 wt % compatibilizer and at least about 0.1 wt % compatibilizer or at least about 0.25 wt % compatibilizer. In another embodiment, the foaming additive includes about 0.1 to 5 wt % compatibilizer or about 0.25 to 3 wt % compatibilizer.

A dispersion aid is an additive that improves the dispersion of a blowing agent in the melt processable composition. The dispersion aid acts to improve the overall uniformity and dispersion of the blowing agent in the melt processable composition by effectively solvating the blowing agent. The compatibilizer can then be used to compatibilizer the solvated blowing agent with the polymeric component. The dispersion aid may be especially useful in connection with hydrophilic blowing agents, in particular solid hydrophilic blowing agents, that are used with a hydrophobic polymeric component. In this situation, the dispersion aid may be hydrophilic in order to effectively solvate the blowing agent. A hydrophilic dispersion aid may be especially applicable for use with solid inorganic blowing agents such as sodium bicarbonate and other carbonate salts. It should be appreciated that a hydrophobic dispersion aid may also be used to solvate a hydrophobic blowing agent when these are used in conjunction with a hydrophilic polymeric component.

For those embodiments where a hydrophilic blowing agent is used, any suitable hydrophilic dispersion aid may also be used. Examples of hydrophilic dispersion aids include water, polyalkylene glycols, polyvinyl alcohol, glycerol, and the like. Suitable examples of hydrophobic dispersion aids include waxes and oils.

The amount of the dispersion aid that is included in the foaming additive or the melt processable composition is dependent on the amount of the blowing agent that is included. Any suitable amount of the blowing agent and/or the dispersion aid may be included. The weight ratio of the blowing agent to the dispersion aid may be at least about 0.5 or at least about 1. The weight ratio of the blowing agent to the dispersion aid may be no more than about 10 or no more than about 6. The weight ratio of the blowing agent to the dispersion aid may also be about 0.6 to about 10, about 1 to 6, or, suitably, 1.5 to 6. It may be desirable to minimize the amount of the dispersion aid used in the foaming additive in order to minimize costs. Thus the dispersion aid may be included in the foaming additive and/or the melt processable composition at the minimum necessary level to achieve acceptable results in the end product. There may be situations, however, where it is desirable to include very high levels of the dispersion aid. For example, in one embodiment, the foaming additive may comprise only the dispersion aid and the blowing agent without any other materials. In this embodiment, the dispersion aid also acts as the carrier for the blowing agent. In another embodiment, the foaming additive may include the dispersion aid, the compatibilizer, and the blowing agent without any additional polymeric carrier material. It should be appreciated that these components/additives may be combined in numerous ways and in widely varying amounts.

Another additive that may be included in the end product is a melt resistant additive. The melt resistant additive is a material that is selected so that it does not melt under the processing conditions, but is capable of deforming (e.g., fibrillating) under shear forces. The melt resistant additive may be used to improve mar and wear properties of the end product. Also, the melt resistant additive serves to reduce melt defects that occur during processing. For example, the addition of a melt resistant additive to a composite may result in a smoother more uniform surface compared to the same composite material without the melt resistant additive.

Any suitable melt resistant additive may be used to improve the properties of the end product. One suitable melt resistant additive is UHMWPE (ultra high molecular weight polyethylene). The UHMWPE may have a MW of at least about 500,000, at least about 750,000, or at least about 1.5 million. The UHMWPE may also have a molecular weight of about 0.5 million to 15 million, about 1 million to 12 million, or, suitably, at least about 1.5 million to 10 million. Another suitable melt resistant additive may be fluorocarbons such as polytetrafluoroethylene.

The melt resistant additive may be included as a component of a foaming additive, a non-foaming additive, or as a separate component that is added directly to the melt processable composition. The amount of the melt resistant additive that may be added to the melt processable composition may vary widely. The melt processable composition may include at least about 0.25 wt % of the melt resistant additive or at least about 0.5 wt % of the melt resistant additive. The melt processable composition may include no more than about 15 wt % of the melt resistant additive, no more than about 10 wt % of the melt resistant additive, or no more than about 8 wt % of the melt resistant additive. The melt processable composition may include about 0.5 to 8 wt % of the melt resistant additive or about 0.75 to about 6 wt % of the melt resistant additive. In one embodiment, the melt processable composition may include about 0.5 to 3 wt % of the melt resistant additive.

In addition to the foaming additive and the melt resistant additive, numerous other additives may also be included in the melt processable composition and, thus in the end product. Other additives may include antioxidants, light stabilizers, fibers (e.g., fiberglass, microfibers, etc.), antiblocking agents, heat stabilizers, impact modifiers (e.g., elastomers), biocides, flame retardants, plasticizers, tackifiers, colorants, processing aids, lubricants, and pigments. Lubricants may include such materials as stearates, metal stearates, stearamides, and/or bis-stearamides. These additional additives may be included with the foaming additive, the melt resistant additive, or any other suitable additive. In one embodiment, all of the various additional additives identified in this paragraph may be combined as a single separate additive complete with a polymeric carrier (if desired). In this way, the customer could purchase the foaming additive separate from a custom tailored set of additional additives. In other embodiments, each additional additive may be added separately from the other additives. In short, the additional additives may be combined with the foaming additives or the individual components of the foaming additive as well as the melt resistant additive in any suitable combination. It should be appreciated that any of the additives described herein may be provided in the form of powders, pellets, granules, or any other extrudable form. The amount and type of additional additives in the melt processable composition may vary depending on the polymeric material used in the polymeric component or matrix and the desired physical properties of the final product.

In one embodiment, the foaming additive may comprise a blowing agent, a polymeric carrier, a compatibilizer, and a dispersion aid. In other embodiments, the foaming additive may comprise a blowing agent, a polymeric carrier, and a melt resistant additive. In another embodiment, the foaming additive may comprise a blowing agent, a polymeric carrier, and a compatibilizer. In yet another embodiment, an additive may comprise a compatibilizer and/or a melt resistant additive. It should be appreciated that additional additives may also be included in any of the embodiments of additives described herein.

The additives may be prepared using any suitable process. In one embodiment, the foaming additive may be prepared by melt processing the various components at temperatures below the activation temperature of the blowing agent (or at temperatures that only result in minor amounts of the blowing agent being activated). The melted additive composition may be formed into pellets or any other suitable form using conventional techniques such as extrusion and the like. A concentrate form of the foaming additive and any of the other additives may be desirable to an end user for handling and storing reasons. A user may use the foaming additive by mixing it in the melt processable composition and heating the melt processable composition to temperatures above the activation temperature of the blowing agent to form a foamed material.

The amount of additives added to the melt processable composition may range widely depending on the circumstances and the desired physical properties of the final product. In one embodiment, the melt processable composition may include at least about 0.1 wt % of additives, at least about 0.25 wt % of additives, or, suitably, at least about 0.5 wt % of additives. In another embodiment, the melt processable composition may include no more than about 8 wt % of additives, no more than about 5 wt % of additives, or, suitably, no more than about 3 wt % of additives. In yet another embodiment, the foamable composite material may include about 0.25 to 5 wt % of additives or about 1 to 3 wt % of additives.

The melt processable composition typically includes a polymeric component, additives, and optionally a filler. A wide variety of polymers conventionally recognized as being suitable for melt processing may be used to form the polymeric component of the melt processable composition. Suitable polymeric materials include polyamides, polyimides, polyurethanes, polyolefins, polystyrenes, polyesters, polycarbonates, polyketones, polyurethanes, polyvinyl resins, polyacrylates, fluoropolymers, polyether imides, polyphenylene sulfides, polyphenylene oxides, polysulfones, polyacetals, polycarbonates, and polymethacrylates. The polymeric materials in the melt processable composition may include hydrocarbon polymers and/or non-hydrocarbon polymers.

Some of the more suitable polymeric materials that may be used in the melt processable composition include high density polyethylene (HDPE), low density polyethylene (LDPE), linear low density polyethylene (LLDPE), polypropylene (PP), polyolefin copolymers (e.g., ethylene-butene, ethylene-octene, ethylene vinyl alcohol), polystyrene, polystyrene copolymers (e.g., high impact polystyrene, acrylonitrile butadiene styrene copolymer), and polyvinyl chloride (PVC). Preferable polymeric materials that may be used in the melt processable composition include polyolefins such as polyethylene and polypropylene and thermoplastic elastomers such as SIS, SEBS, and SBS. It also may be desirable to use thermoplastic polymeric materials so that the polymeric component of the foamable composition is also thermoplastic. It should be appreciated that the term “thermoplastic” as used herein refers to a material that softens upon heating and becomes firm or hardens upon cooling.

The melt processable composition may optionally include a wide variety of fillers. For example, the melt processable composition may include mineral fillers (e.g., talc, mica, clay, silica, alumina) and cellulosic materials (e.g., wood flour, wood fibers, sawdust, wood shavings, newsprint, paper, flax, hemp, rice hulls, corn hulls, kenaf, jute, sisal, peanut shells). The amount of filler in the melt processable composition may vary depending upon the polymeric materials used and the desired physical properties of the foamed material. The use of the additives described above may allow the user to produce a foamed composite material that that is highly filled, lightweight, and relatively strong. In one embodiment, the foamed composite material may include at least about 60 wt % filler (e.g., cellulosic material such as wood flour or wood fiber), have a density of no more than about 0.7 g/cm³, and a flexural modulus of at least about 600 MPa.

The melt processable composition can be prepared by any of a variety of ways. For example, the polymeric material and the additive can be combined together by any of the blending means usually employed in the plastics industry, such as with a compounding mill, a Banbury mixer, or a mixing extruder in which the processing additive is uniformly distributed throughout the polymeric component. The additive and the polymer material may each be provided in the form, for example, of a powder, a pellet, a granular product, or a melt. The mixing operation is most conveniently carried out at a temperature above the melting point or softening point of the additive and the polymeric material, though it is also feasible to blend the components in the solid state as particulates and then uniformly distribute the components by feeding the blend to melt processing equipment such as a twin-screw melt extruder. The resulting melt-blended mixture can be either extruded directly into the form of the final product shape or pelletized or otherwise comminuted into a desired particulate size or size distribution and fed to an extruder, which may be a single-screw extruder, that melt-processes the blended mixture to form the final product shape.

Melt-processing typically is performed at a temperature from 120° to 300° C., although optimum operating temperatures are selected depending upon the melting point, melt viscosity, and thermal stability of the composition. For example, if a filler such as a cellulosic material (e.g., wood flour or wood fiber) is included in the melt processable composition, it is generally desirable to process the composition at temperatures below the decomposition temperature of the filler. Different types of melt processing equipment, such as extruders, may be used to process the melt processable compositions of this invention.

### EXAMPLES

The following examples are provided to further describe the subject matter disclosed herein. The following examples should not be considered as being limiting in any way. Table 1 contains a list of materials used in the examples.

TABLE 1

| Material | Description |
|---|---|
| PP | HB1602, MFR = 12 g/10 min, polypropylene available from BP Inc. |
| | (Warrenville, IL) |
| HDPE | HD12450, MFR = 12 g/10 min (ASTM D1238), MP = 123° C. [vicat |
| | softening point], high density polyethylene available from Dow |
| | Chemical Company (Midland, MI) |
| Elastomeric Carrier | Engage 8407, MFR = 30 g/10 min (ASTM D1238), M.P. = 65° C., |
| | ethylene-octene copolymer available from PolyOne Corp. (Avon |
| | Lake, OH) |
| Blowing Agent A | Sodium Bicarbonate (NaHCO₃), available from Brainerd Chemical |
| | Company (Tulsa, OK) |
| Dispersion Aid | Carbowax 8000, MP = 60° C., MW = 7000-9000, polyethylene |
| | glycol available from Dow Chemical Company (Midland, MI) |
| Compatibilizer | Unithox 450, MP = 91° C., polyethylene-b-polyethylene oxide |
| | polymer, commercially available from Baker Petrolite Inc. |
| | (Sugarland, TX) |
| Celogen (Commercial | Celogen 125FF (85 wt % diazenedicarboxamide, 15 wt % fatty acid, |
| Foaming Additive) | calcium salt), available from Chemtura Inc (Middlebury, CT) |
| UHMWPE | GUR 4150, MW = 9.2 MM g/mol, Vicat softening point = 80° C. |
| | (ASTM D1525), available from Ticona (Summit, NJ) |
| PTFE | PA 5933, available from Dyneon LLC (Oakdale, MN) |
| Wood Fiber | 40 mesh hardwood fiber available from American Wood Fibers |
| | (Schofield, WI) |

### Example 1

In this example, a number of foaming additives were prepared according to the following procedure. The formulations for each sample of foaming additive is shown in Table 2. The materials were dry mixed in a plastic bag and gravity fed into a 27 mm conical twin screw extruder fitted with a 0.32 cm dual strand die (commercially available from C.W. Brabender, South Hackensack, N.J.). All samples were processed at 75 rpm screw speed using the following temperature profile: Zone 1=75° C., Zone 2=100° C., Zone 3=125° C., Zone 4=125° C. The resulting strands were extruded into a cold-water bath and subsequently pelletized into approximately 0.25 cm diameter pellets. The resulting foaming additives were allowed to dry at room temperature 24 hours prior to use.

TABLE 2

| | Elastomeric | Blowing Agent | Dispersion | Compatibilizer |
|---|---|---|---|---|
| Sample | Carrier (wt %) | A (wt %) | Aid (wt %) | (wt %) |
| 1 | 50 | 50 | 0 | 0 |
| 2 | 70 | 30 | 0 | 0 |
| 3 | 30 | 70 | 0 | 0 |
| 4 | 50 | 37.5 | 11.5 | 1 |
| 5 | 30 | 57.5 | 11.5 | 1 |
| 6 | 70 | 17.5 | 11.5 | 1 |
| 7 | 55 | 37.5 | 6.5 | 1 |
| 8 | 41.5 | 37.5 | 20 | 1 |
| 9 | 51 | 37.5 | 1.5 | 0 |
| 10 | 30 | 52 | 17 | 1 |
| 11 | 40 | 45 | 14 | 1 |
| 12 | 60 | 30 | 9 | 1 |
| 13 | 70 | 22.5 | 6.5 | 1 |

### Example 2

A number of composite materials were prepared using the following protocol. Wood fiber was predried for 4 hours at 93.33° C. in a resin dryer. Polymeric resin (PP or HDPE), wood fiber and additives (e.g., foaming additive, Celogen, blowing agent, UHMWPE, PTFE) were then dry mixed in a plastic bag and gravity fed into a 27 mm conical twin screw extruder fitted with a 0.508 cm square profile strand die (commercially available from C.W. Brabender, South Hachensack, N.J.). All samples were processed at 75 rpm screw speed using the following temperature profile: Zone 1=145° C., Zone 2=185° C., Zone 3=200° C., Zone 4=200° C. The resulting strands were extruded to approximately 6 inches in length and immediately quenched in a cold-water bath.

The surface quality and density of the composite materials were then determined as follows. The surface quality of the composite materials was visually analyzed and ranked on a 1-10 scale with 1 being perfectly smooth and 10 being extremely rough. The density of each sample of composite material was determined using a water displacement method. Specifically, the mass of each sample was determined using an analytical balance (sample specimen was dry), and the sample volume was subsequently determined by submersing the sample in a graduated cylinder filled with water. The density (g/cm³) was calculated by dividing the mass of the sample by the volume of water displaced.

Tables 3-10 below show the results for a variety of different composite materials. It should be noted that foaming additive A referenced in Tables 3, 5, 7, and 11 is sample 4 of the foaming additive shown in Table 2 and prepared according to the procedure in Example 1.

Table 3 shows the formulations of a number of composite materials prepared using the procedure described above. As shown in Table 3, the composite materials formed in samples 14 and 18 were not foamed, while the remaining samples were foamed using blowing agent A alone (sodium bicarbonate), Celogen, or Foaming Additive A. Table 4 shows the surface qualities and densities obtained for the samples shown in Table 3. As shown in Table 4, samples 14-21 demonstrate that the addition of foaming additives (i.e., blowing agent A, Celogen, or Foaming Additive A) into the PP and HDPE based composite formulations all resulted in density reductions when compared to samples that did not have foaming additives (i.e., samples 4 and 8). However, the surface quality of the composites is reduced when the foaming additives were added to these formulations. The use of foaming additive A provided the greatest density reduction while maintaining the surface quality close to the same as the composite materials that were not foamed.

TABLE 3

| | | | Wood | Blowing | | Foaming |
|---|---|---|---|---|---|---|
| | PP | HDPE | Fiber | Agent A | Celogen | Additive A |
| Sample | (wt %) | (wt %) | (wt %) | (wt %) | (wt %) | (wt %) |
| 14 | 50 | — | 50 | — | — | — |
| 15 | 49 | — | 50 | 1 | — | |
| 16 | 49 | — | 50 | — | 1 | |
| 17 | 49 | — | 50 | — | — | 1 |
| 18 | — | 50 | 50 | — | — | — |
| 19 | — | 49 | 50 | 1 | — | |
| 20 | — | 49 | 50 | — | 1 | |
| 21 | — | 49 | 50 | — | — | 1 |

TABLE 4

| | | Surface Quality |
|---|---|---|
| Sample | Density (g/cm³) | (1 to 10) |
| 14 | 1.06 | 6 |
| 15 | 0.96 | 10 |
| 16 | 0.84 | 9 |
| 17 | 0.75 | 7 |
| 18 | 1.05 | 5 |
| 19 | 0.95 | 9 |
| 20 | 0.87 | 8 |
| 21 | 0.79 | 6 |

Table 5 shows a number of additional formulations of composite materials prepared according to the procedure described above. In the samples shown in Table 5, the same additives were used to foam the composite material as those shown in Table 3. However, the samples in Table 5 also included varying levels of another additive—UHMWPE. Table 6 shows the surface qualities and densities obtained for these formulations. As shown in Table 6, the addition of UHMWPE in the samples resulted in improved density reductions and surface quality when compared to the samples that did not have UHMWPE (Tables 3-4).

TABLE 5

| | | | Wood | Blowing | | Foaming | |
|---|---|---|---|---|---|---|---|
| | PP | HDPE | Fiber | Agent A | Celogen | Additive A | UHMWPE |
| Sample | (wt %) | (wt %) | (wt %) | (wt %) | (wt %) | (wt %) | (wt %) |
| 22 | 48 | — | 50 | 1 | — | — | 1 |
| 23 | 47 | — | 50 | 1 | — | — | 2 |
| 24 | 44 | — | 50 | 1 | — | — | 5 |
| 25 | — | 48 | 50 | 1 | — | — | 1 |
| 26 | — | 47 | 50 | 1 | — | — | 2 |
| 27 | — | 44 | 50 | 1 | — | — | 5 |
| 28 | 48 | — | 50 | — | 1 | — | 1 |
| 29 | 47 | — | 50 | — | 1 | — | 2 |
| 30 | 44 | — | 50 | — | 1 | — | 5 |
| 31 | — | 48 | 50 | — | 1 | — | 1 |
| 32 | — | 47 | 50 | — | 1 | — | 2 |
| 33 | — | 44 | 50 | — | 1 | — | 5 |
| 34 | 48 | — | 50 | — | — | 1 | 1 |
| 35 | 47 | — | 50 | — | — | 1 | 2 |
| 36 | 44 | — | 50 | — | — | 1 | 5 |
| 37 | — | 48 | 50 | — | — | 1 | 1 |
| 38 | — | 47 | 50 | — | — | 1 | 2 |
| 39 | — | 44 | 50 | — | — | 1 | 5 |

TABLE 6

| | | Surface Quality |
|---|---|---|
| Sample | Density (g/cm³) | (1 to 10) |
| 22 | 0.85 | 6 |
| 23 | 0.80 | 4 |
| 24 | 0.77 | 2 |
| 25 | 0.84 | 5 |
| 26 | 0.82 | 3 |
| 27 | 0.78 | 1 |
| 28 | 0.77 | 5 |
| 29 | 0.75 | 3 |
| 30 | 0.69 | 2 |
| 31 | 0.81 | 4 |
| 32 | 0.78 | 1 |
| 33 | 0.74 | 1 |
| 34 | 0.68 | 4 |
| 35 | 0.62 | 3 |
| 36 | 0.58 | 1 |
| 37 | 0.76 | 3 |
| 38 | 0.72 | 1 |
| 39 | 0.72 | 1 |

Table 7 shows additional samples of composite materials that have formulations similar to those in Table 5, except that PTFE is added instead of UHMWPE. Table 8 shows the surface qualities and densities obtained for the formulations shown in Table 7. The results show that the addition PTFE in the samples resulted in improved density reductions and surface quality when compared to formulations in the comparative examples that did not have PTFE.

TABLE 7

| | | | | Blowing | | Foaming | |
|---|---|---|---|---|---|---|---|
| | PP | HDPE | Wood Fiber | Agent A | Celogen | Additive A | PTFE |
| Sample | (wt %) | (wt %) | (wt %) | (wt %) | (wt %) | (wt %) | (wt %) |
| 40 | 48 | — | 50 | 1 | — | — | 1 |
| 41 | — | 48 | 50 | 1 | — | — | 1 |
| 42 | 48 | — | 50 | — | 1 | — | 1 |
| 43 | — | 48 | 50 | — | 1 | — | 1 |
| 44 | 48 | — | 50 | — | — | 1 | 1 |
| 45 | — | 48 | 50 | — | — | 1 | 1 |

TABLE 8

| | | Surface Quality |
|---|---|---|
| Sample | Density (g/cm³) | (1 to 10) |
| 40 | 0.81 | 1 |
| 41 | 0.82 | 1 |
| 42 | 0.77 | 1 |
| 43 | 0.83 | 1 |
| 44 | 0.64 | 1 |
| 45 | 0.75 | 1 |

Table 9 shows additional examples of composite materials prepared according to the procedure described above. As shown in Table 9, samples 46-64 were prepared using the foaming additives 1-13 from Table 2. Table 10 shows the densities of the composite materials having these formulations. The results show that foaming additives 4-13 were more effective at reducing density when compared to foaming additives 1-3.

TABLE 9

| | Foaming | PP | Wood Fiber | Foaming |
|---|---|---|---|---|
| Sample | Additive | (wt %) | (wt %) | Additive (wt %) |
| 46 | 1 | 99 | — | 1 |
| 47 | 2 | 99 | — | 1 |
| 48 | 3 | 99 | — | 1 |
| 49 | 4 | 99 | — | 1 |
| 50 | 5 | 99 | — | 1 |
| 51 | 6 | 99 | — | 1 |
| 52 | 7 | 99 | — | 1 |
| 53 | 8 | 99 | — | 1 |
| 54 | 9 | 99 | — | 1 |
| 55 | 10 | 99 | — | 1 |
| 56 | 11 | 99 | — | 1 |
| 57 | 12 | 99 | — | 1 |
| 58 | 13 | 99 | — | 1 |
| 59 | 1 | 49 | 50 | 1 |
| 60 | 2 | 49 | 50 | 1 |
| 61 | 3 | 49 | 50 | 1 |
| 62 | 4 | 49 | 50 | 1 |
| 63 | 5 | 49 | 50 | 1 |
| 64 | 6 | 49 | 50 | 1 |
| 65 | 7 | 49 | 50 | 1 |
| 66 | 8 | 49 | 50 | 1 |
| 67 | 9 | 49 | 50 | 1 |
| 68 | 10 | 49 | 50 | 1 |
| 69 | 11 | 49 | 50 | 1 |
| 70 | 12 | 49 | 50 | 1 |
| 71 | 13 | 49 | 50 | 1 |

TABLE 10

| Sample | Density (g/cm³) |
|---|---|
| 46 | 0.90 |
| 47 | 0.79 |
| 48 | 0.86 |
| 49 | 0.55 |
| 50 | 0.68 |
| 51 | 0.61 |
| 52 | 0.64 |
| 53 | 0.74 |
| 54 | 0.65 |
| 55 | 0.52 |
| 56 | 0.40 |
| 57 | 0.47 |
| 58 | 0.74 |
| 59 | 0.85 |
| 60 | 0.87 |
| 61 | 0.88 |
| 62 | 0.65 |
| 63 | 0.69 |
| 64 | 0.69 |
| 65 | 0.69 |
| 66 | 0.68 |
| 67 | 0.65 |
| 68 | 0.65 |
| 69 | 0.64 |
| 70 | 0.64 |
| 71 | 0.62 |

### Example 3

The mechanical properties of a number of composite materials was tested as follows. Initially, composite materials having the formulations shown in Table 11 were prepared using the procedure described in Example 2 except that the composite materials were extruded though a 7.62 cm×64 cm profile die using a 27 mm parallel twin screw extruder (commercially available from American Leistritz Corporation, Somerville, N.J.). The resulting samples were quenched in a cold water bath and machined into 12 mm×6.4 mm×120 mm test specimens. The samples were allowed to dwell for 24 hours at constant temperature and humidity and subsequently tested for flexural properties as specified in ASTM D790 using a mechanical property-testing machine commercially available from MTS Corporation (Eden Prairie, Minn.). Table 12 shows the results of the mechanical properties testing.

TABLE 11

| | | | Foaming |
|---|---|---|---|
| | | Wood Fiber | Additive |
| Sample | HDPE (wt %) | (wt %) | A (wt %) |
| 72 | 30 | 70 | — |
| 73 | 40 | 60 | — |
| 74 | 60 | 40 | — |
| 75 | 30 | 70 | 1 |
| 76 | 40 | 60 | 1 |
| 77 | 60 | 40 | 1 |

TABLE 12

| | Flexural | |
|---|---|---|
| Sample | Modulus (MPa) | Density (g/cm³) |
| 72 | 1200 | 1.03 |
| 73 | 1340 | 1.05 |
| 74 | 2100 | 1.08 |
| 75 | 790 | 0.61 |
| 76 | 940 | 0.67 |
| 77 | 1300 | 0.72 |

### ILLUSTRATIVE EMBODIMENTS

Reference is made in the following to a number of illustrative embodiments of the subject matter described herein. The following embodiments illustrate only a few selected embodiments that may include the various features, characteristics, and advantages of the subject matter as presently described. Accordingly, the following embodiments should not be considered as being comprehensive of all of the possible embodiments. Also, features and characteristics of one embodiment may and should be interpreted to equally apply to other embodiments or be used in combination with any number of other features from the various embodiments to provide further additional embodiments, which may describe subject matter having a scope that varies (e.g., broader, etc.) from the particular embodiments explained below. Accordingly, any combination of any of the subject matter described herein is contemplated.

According to one embodiment, a foaming additive comprises: a blowing agent; and an amphiphilic polymer having a nonionic hydrophilic segment. The blowing agent may be solid. The blowing agent may be inorganic. The blowing agent may include a carbonate salt. The blowing agent may include sodium bicarbonate and/or sodium carbonate. The amphiphilic polymer may be an amphiphilic block copolymer. The amphiphilic block copolymer may be a diblock copolymer. The amphiphilic polymer may include a polyolefin segment and a polyalkylene oxide segment. The foaming additive may comprise at least about 5 wt % of the blowing agent. The foaming additive may comprise at least about 10 wt % of the blowing agent. The foaming additive may comprise no more than 10 wt % of the amphiphilic polymer. The foaming additive may comprise no more than 5 wt % of the amphiphilic polymer. The foaming additive may comprise no more than about 3 wt % of the amphiphilic polymer. The foaming additive may further comprise at least about 10 wt % of a thermoplastic polymeric carrier. The thermoplastic polymeric carrier may have a melting point of no more than about 150° C. The foaming additive may further comprise a hydrophilic dispersion aid. The hydrophilic dispersion aid may include water, polyalkylene glycol, polyvinyl alcohol, and/or glycerol. The hydrophilic dispersion aid may include polyalkylene glycol. A weight ratio of the blowing agent to the hydrophilic dispersion aid may be about 0.6 to 10. The weight ratio may be about 1.5 to 6. The foaming additive may further comprise a thermoplastic polymeric carrier; wherein the foaming additive comprises about 20 to 60 wt % of the thermoplastic polymeric carrier; about 10 to 60 wt % of the blowing agent; and no more than about 10 wt % of the amphiphilic polymer. The foaming additive may further comprise a thermoplastic polymeric carrier; and a hydrophilic dispersion aid; wherein the blowing agent is hydrophilic; wherein the foaming additive comprises about 30 to 55 wt % of the thermoplastic polymeric carrier; about 15 to 50 wt % of the blowing agent; and no more than about 5 wt % of the amphiphilic polymer; and wherein a weight ratio of the blowing agent to the hydrophilic dispersion aid is about 0.6 to 10.

According to another embodiment, a foaming additive comprises: a blowing agent; and an amphiphilic block copolymer. The blowing agent may be solid. The blowing agent may be inorganic. The blowing agent may include a carbonate salt. The blowing agent may include sodium bicarbonate and/or sodium carbonate. The amphiphilic block copolymer may be nonionic. The amphiphilic block copolymer may be a diblock copolymer. The amphiphilic block copolymer may include a polyolefin block and a polyalkylene oxide block. The foaming additive may comprise at least about 5 wt % of the blowing agent. The foaming additive may comprise at least about 10 wt % of the blowing agent. The foaming additive may comprise no more than 10 wt % of the amphiphilic block copolymer. The foaming additive may comprise no more than 5 wt % of the amphiphilic block copolymer. The foaming additive may comprise no more than about 3 wt % of the amphiphilic block copolymer. The foaming additive may further comprise at least about 10 wt % of a thermoplastic polymeric carrier. The thermoplastic polymeric carrier may have a melting point of no more than about 150° C. The thermoplastic polymeric carrier may have a melting point of no more than about 125° C. The foaming additive may further comprise a hydrophilic dispersion aid. The hydrophilic dispersion aid may include water, polyalkylene glycol, polyvinyl alcohol, and/or glycerol. The hydrophilic dispersion aid may include polyalkylene glycol. A weight ratio of the blowing agent to the hydrophilic dispersion aid may be about 0.6 to 10. The weight ratio may be about 1.5 to 6. The foaming additive may further comprise a thermoplastic polymeric carrier; wherein the foaming additive comprises about 20 to 60 wt % of the thermoplastic polymeric carrier; about 10 to 60 wt % of the blowing agent; and no more than about 10 wt % of the amphiphilic block copolymer. The foaming additive may further comprise a thermoplastic polymeric carrier; and a hydrophilic dispersion aid; wherein the blowing agent is hydrophilic; wherein the foaming additive comprises about 30 to 55 wt % of the thermoplastic polymeric carrier; about 15 to 50 wt % of the blowing agent; and no more than about 5 wt % of the amphiphilic block copolymer; and wherein a weight ratio of the blowing agent to the hydrophilic dispersion aid is about 0.6 to 10.

According to another embodiment, a foaming additive comprises: a thermoplastic polymeric carrier; one or more carbonate salts; an amphiphilic block copolymer. The thermoplastic polymeric carrier may have a melting point of no more than about 150° C. The one or more carbonate salts may include sodium carbonate and/or sodium bicarbonate. The amphiphilic block copolymer may be nonionic. The amphiphilic block copolymer may be a diblock copolymer. The amphiphilic block copolymer may include a polyolefin block and a polyalkylene oxide block. The foaming additive may comprise at least about 5 wt % of the one or more carbonate salts. The foaming additive may comprise at least about 10 wt % of the one or more carbonate salts. The foaming additive may comprise no more than 10 wt % of the amphiphilic block copolymer. The foaming additive may comprise no more than 5 wt % of the amphiphilic block copolymer. The foaming additive may comprise no more than about 3 wt % of the amphiphilic block copolymer. The foaming additive may further comprise at least about 10 wt % of the thermoplastic polymeric carrier. The foaming additive may further comprise a hydrophilic dispersion aid. The hydrophilic dispersion aid may include water, polyalkylene glycol, polyvinyl alcohol, and/or glycerol. The hydrophilic dispersion aid may include polyalkylene glycol. A weight ratio of the one or more carbonate salts to the hydrophilic dispersion aid may be about 0.6 to 10. The weight ratio of the one or more carbonate salts to the hydrophilic dispersion aid may be about 1.5 to 6. The foaming additive may comprise about 20 to 60 wt % of the thermoplastic polymeric carrier; about 10 to 60 wt % of the one or more carbonate salts; and no more than about 10 wt % of the amphiphilic block copolymer. The foaming additive may further comprise a hydrophilic dispersion aid; wherein the foaming additive comprises about 30 to 55 wt % of the thermoplastic polymeric carrier; about 15 to 50 wt % of the one or more carbonate salts; and no more than about 5 wt % of the amphiphilic block copolymer; and wherein a weight ratio of the one or more carbonate salts to the hydrophilic dispersion aid is about 0.6 to 10.

According to another embodiment, a method of producing a foamed composite material comprises: mixing a filler, a blowing agent, an amphiphilic block copolymer, and a thermoplastic polymeric component to provide a first blend; activating the blowing agent to provide a foamed blend. The activating step may include heating the first blend. The activating step may include extruding the first blend. The filler may include cellulosic material. The thermoplastic polymeric component may be a first thermoplastic polymeric component; the mixing step may include mixing a foaming additive, the first thermoplastic polymeric component, and the filler; and the foaming additive may include the blowing agent and the amphiphilic block copolymer. The foaming additive may include a second thermoplastic polymeric component or carrier.

According to another embodiment, a method of producing a foamed composite material comprises: heating a first blend that includes a filler, a blowing agent, a nonionic amphiphilic copolymer, and a thermoplastic polymeric component at a temperature sufficient to form a foamed blend. The filler may include cellulosic material. The method may comprise extruding the first blend. The method may comprise cooling the foamed blend.

According to another embodiment, a foaming additive comprises: at least about 5 wt % of blowing agent; and an amphiphilic polymer.

According to another embodiment, a foaming additive comprises: a blowing agent; and a polyalkylene glycol. The polyalkylene glycol may include polyethylene glycol. The foaming additive may further comprise a compatibilizer.

According to another embodiment, as foaming additive comprises: a hydrophilic blowing agent; and a hydrophilic dispersion aid which is capable of solvating the hydrophilic blowing agent. A weight ratio of the hydrophilic blowing agent to the hydrophilic dispersion aid may be about 0.6 to 10. The weight ratio of the hydrophilic blowing agent to the hydrophilic dispersion aid may be about 1.5 to 6.

According to another embodiment, a foaming additive comprises: a hydrophilic blowing agent; and a hydrophilic dispersion aid; wherein a weight ratio of the hydrophilic blowing agent to the hydrophilic dispersion aid is about 0.6 to 10. The weight ratio is about 1.5 to 6.

According to another embodiment, a method of producing a foamed material comprises: mixing a blowing agent, an amphiphilic block copolymer, and a thermoplastic polymeric component to provide a first blend; activating the blowing agent to provide a foamed blend. The activating step may include heating the first blend. The activating step may include extruding the first blend. The first blend may include a filler. The filler may include cellulosic material. The thermoplastic polymeric component may be a first thermoplastic polymeric component; the mixing step may include mixing a foaming additive and the first thermoplastic polymeric component; and the foaming additive may include the blowing agent and the amphiphilic block copolymer. The foaming additive may include a second thermoplastic polymeric component or carrier.

According to another embodiment, a method of producing a foamed material comprises: heating a first blend that includes a blowing agent, a nonionic amphiphilic copolymer, and a thermoplastic polymeric component at a temperature sufficient to form a foamed blend. The first blend may include a filler. The method may comprise extruding the first blend. The method may comprise cooling the foamed blend.

According to another embodiment, a method of producing a foamed material comprises: activating a blowing agent in a first blend that also includes a nonionic amphiphilic polymer (or an amphiphilic block copolymer) and a thermoplastic polymeric component to form a foamed blend. The first blend may include a filler. The method may comprise extruding the first blend. The method may comprise cooling the foamed blend.

According to another embodiment, a melt processable composition or, in some cases, a foamable composition may be prepared that includes any of the foaming additives described herein. According to another embodiment, a foamed composite material may be produced using any of the foaming additives described herein.

According to another embodiment, a foamed composite material may be produced using and/or including any of the methods described herein. The foamed composite material may have a density of no more than about 0.75 g/cm³. The foamed composite material may have a density of no more than about 0.7 g/cm³.

According to another embodiment, a foamable composition comprises: a blowing agent; and a melt resistant additive. The melt resistant additive may comprise polyethylene having a molecular weight of at least about 500,000 and/or polytetrafluoroethylene

According to another embodiment, a foamable composition comprises: a blowing agent; and a polyolefin having a molecular weight of at least about 500,000 and/or a fluoropolymer. The polyolefin may have a molecular weight of at least about 1,000,000.

According to another embodiment, a foamed composite material comprises: at least about 60 wt % filler; and a thermoplastic polymeric component; wherein the foamed composite material has a density of no more than 0.7 g/cm³ and a flexural modulus of at least about 600 MPa.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., consensus definitions from widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

As used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive (e.g., “x or y” means one or both x or y). Likewise, as used herein, the term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc., used in the specification are understood as modified in all instances by the term “about.” At the very least, and not as an attempt to limit the application of the doctrine of equivalents to the claims, each numerical parameter recited in the specification or claims which is modified by the term “about” should at least be construed in light of the number of recited significant digits and by applying ordinary rounding techniques. Moreover, all ranges disclosed herein are to be understood to encompass any and all subranges subsumed therein. For example, a stated range of 1 to 10 should be considered to include any and all subranges between and inclusive of the minimum value of 1 and the maximum value of 10; that is, all subranges beginning with a minimum value of 1 or more and ending with a maximum value of 10 or less (e.g., 5.5 to 10).

What is claimed is:

1. A foaming additive comprising:
a blowing agent; and
an amphiphilic polymer having a nonionic hydrophilic segment.

2. The foaming additive of claim 1 wherein the blowing agent is inorganic.

3. The foaming additive of claim 2 wherein the blowing agent includes a carbonate salt.

4. The foaming additive of claim 3 wherein the blowing agent includes sodium bicarbonate and/or sodium carbonate.

5. The foaming additive of claim 1 wherein the amphiphilic polymer is an amphiphilic block copolymer.

6. The foaming additive of claim 1 wherein the amphiphilic polymer includes a polyolefin segment and a polyalkylene oxide segment.

7. The foaming additive of claim 1 comprising at least about 5 wt % of the blowing agent.

8. The foaming additive of claim 1 further comprising at least about 10 wt % of a polymeric carrier.

9. The foaming additive of claim 1 further comprising a hydrophilic dispersion aid.

10. The foaming additive of claim 9 wherein the hydrophilic dispersion aid includes water, polyalkylene glycol, polyvinyl alcohol, and/or glycerol.

11. The foaming additive of claim 1 further comprising
a polymeric carrier;
wherein the foaming additive comprises
about 20 to 60 wt % of the polymeric carrier;
about 10 to 60 wt % of the blowing agent; and
no more than about 10 wt % of the amphiphilic polymer.

12. A foamed material prepared using the foaming additive of claim 1.

13. A melt processable composition comprising the foaming additive of claim 1 and a thermoplastic polymeric component.

14. A foaming additive comprising:
a blowing agent; and
an amphiphilic block copolymer.

15. The foaming additive of claim 14 wherein the blowing agent is solid.

16. The foaming additive of claim 14 wherein the blowing agent is inorganic.

17. The foaming additive of claim 16 wherein the blowing agent includes a carbonate salt.

18. The foaming additive of claim 17 wherein the blowing agent includes sodium bicarbonate and/or sodium carbonate.

19. The foaming additive of claim 14 wherein the amphiphilic block copolymer includes a polyolefin block and a polyalkylene oxide block.

20. The foaming additive of claim 14 comprising at least about 5 wt % of the blowing agent.

21. The foaming additive of claim 14 further comprising at least about 10 wt % of a polymeric carrier.

22. The foaming additive of claim 14 further comprising a hydrophilic dispersion aid.

23. The foaming additive of claim 22 wherein the hydrophilic dispersion aid includes water, polyalkylene glycol, polyvinyl alcohol, and/or glycerol.

24. The foaming additive of claim 14 further comprising
a polymeric carrier;
wherein the foaming additive comprises
about 20 to 60 wt % of the polymeric carrier;
about 10 to 60 wt % of the blowing agent; and
no more than about 10 wt % of the amphiphilic block copolymer.

25. A foamed material prepared using the foaming additive of claim 14.

26. A melt processable composition comprising the foaming additive of claim 14 and a thermoplastic polymeric component.

27. A foaming additive comprising:
a polymeric carrier;
one or more carbonate salts;
an amphiphilic block copolymer.

28. The foaming additive of claim 27 wherein the polymeric carrier has a melting point of no more than about 150° C.

29. The foaming additive of claim 27 wherein the one or more carbonate salts include sodium carbonate and/or sodium bicarbonate.

30. The foaming additive of claim 27 wherein the amphiphilic block copolymer is nonionic.

31. The foaming additive of claim 27 wherein the amphiphilic block copolymer includes a polyolefin block and a polyalkylene oxide block.

32. The foaming additive of claim 27 comprising at least about 10 wt % of the one or more carbonate salts.

33. The foaming additive of claim 27 comprising no more than 5 wt % of the amphiphilic block copolymer.

34. The foaming additive of claim 27 further comprising at least about 20 wt % of the polymeric carrier.

35. The foaming additive of claim 27 further comprising a hydrophilic dispersion aid.

36. The foaming additive of claim 35 wherein the hydrophilic dispersion aid includes water, polyalkylene glycol, polyvinyl alcohol, and/or glycerol.

37. The foaming additive of claim 35 wherein a weight ratio of the one or more carbonate salts to the hydrophilic dispersion aid is about 1 to 6.

38. The foaming additive of claim 27 further comprising
a hydrophilic dispersion aid;
wherein the foaming additive comprises
about 30 to 55 wt % of the polymeric carrier;
about 15 to 50 wt % of the one or more carbonate salts; and
no more than about 5 wt % of the amphiphilic block copolymer; and
wherein a weight ratio of the one or more carbonate salts to the hydrophilic dispersion aid is about 0.6 to 10.

39. A foamed material prepared using the foaming additive of claim 27.

40. The foamed material of claim 39 wherein the foamed material is a structural building member or an automotive component.

41. A melt processable composition comprising the foaming additive of claim 27 and a thermoplastic polymeric component.

42. A method of producing a foamed composite material comprising:
mixing a foaming additive, a filler, and a first thermoplastic polymeric component to provide a first blend;
activating the blowing agent to provide a foamed blend;
wherein the foaming additive includes a blowing agent and an amphiphilic block copolymer.

43. A method of producing a foamed composite material comprising:
heating a first blend that includes a filler, a blowing agent, an amphiphilic block copolymer, and a thermoplastic polymeric component at a temperature sufficient to form a foamed blend.

44. A foaming additive comprising:
a hydrophilic blowing agent; and
a hydrophilic dispersion aid;
wherein a weight ratio of the hydrophilic blowing agent to the hydrophilic dispersion aid is about 0.6 to 10.

45. A foaming additive comprising:
a compatibilizer;
a hydrophilic blowing agent; and
a hydrophilic dispersion aid.

46. A melt processable composition comprising:
a blowing agent; and
a polyolefin having a molecular weight of at least about 500,000 and/or a fluoropolymer.

47. A foamed composite material comprising:
at least about 60 wt % filler; and
a thermoplastic polymeric component;
wherein the foamed composite material has a density of no more than 0.7 g/cm³ and a flexural modulus of at least about 600 MPa.
